(19) United States
(12) Patent Application Publication
(10) Pub. No.: US 2023/0385539 A1
(43) Pub. Date: Nov. 30, 2023

(54) ELECTRONIC FILE TRANSMISSION CONTROL APPARATUS AND METHOD

(71) Applicant: STAR ONE Co., Ltd., Yokohama-shi (JP)

(72) Inventor: Seiji KAWASHIMA, Yokohama-shi (JP)

(21) Appl. No.: 18/232,969

(22) Filed: Aug. 11, 2023

Related U.S. Application Data
(63) Continuation of application No. PCT/JP2022/004853, filed on Feb. 8, 2022.

(30) Foreign Application Priority Data
Feb. 16, 2021 (JP) 2021-022608

(51) Int. Cl. G06F 40/186; G06F 40/103; H04L 51/08

(52) U.S. Cl. CPC G06F 40/186; G06F 40/103; H04L 51/08

(57) ABSTRACT

An electronic file representing an electronic document is generated relatively easily. In an email window, an email address of a transmission source of an electronic file is input to a transmission source address input area, an email address of a transmission destination of the electronic file is input to a transmission destination address input area, and an email address including an electronic file generation ID and a process server domain name is input to a cc address input area. When content to be reflected in an electronic document is input to a content input area and an email is transmitted to a transmission destination user and a process server, an electronic file is generated in the process server and transmitted to the transmission destination.

### CROSS-REFERENCE TO RELATED APPLICATIONS

This application is a Continuation of PCT International Application No. PCT/JP2022/004853 filed on Feb. 8, 2022, which claims priority under 35 U.S.C. § 119(a) to Japanese Patent Application No. 2021-022608 filed on Feb. 16, 2021. Each of the above application(s) is hereby expressly incorporated by reference, in its entirety, into the present application.

### TECHNICAL FIELD

The present invention relates to an electronic file transmission control apparatus and method, and a non-transitory tangible recording medium storing a program for controlling a computer of an electronic file transmission control apparatus.

### BACKGROUND ART

A portable document format (PDF) file is a file of a format in which a layout is less likely to be broken in a state of being printed by a printer or the like and a state of being displayed on a display screen or the like. However, since an object may be arranged at a position not intended by a user in the PDF file, a PDF file generation method in which various objects included in a document file are arranged at positions intended by the user is conceivable (Patent Literature 1).

### CITATION LIST

### Patent Literature

Patent Literature 1: Japanese Patent No. 6799700

### SUMMARY OF INVENTION

When a document file created using document creation software is converted into an electronic file having a file format such as the PDF file and the converted electronic file is to be transmitted to a third party, it is conceivable that the electronic file is attached to an email and transmitted. When the electronic file is transmitted several times in this way, processing of converting the document file into the electronic file, attaching the electronic file to the email, and transmitting the electronic file is performed each time, which is a relatively troublesome work.

An object of the present invention is to enable a third party to read an electronic document represented by an electronic file having the above format in a relatively simple manner.

An electronic file transmission control apparatus according to the present invention comprises: a first receiving unit that receives first transmission destination data representing a transmission destination (a transmission destination different from a transmission source, a transmission destination added in addition to the transmission source, and the like) of an electronic file having a file format capable of displaying, on a display screen, an electronic document in which a character string is represented in the same state as a state where the character string is represented on a paper sheet, and text data representing a character string to be transmitted to the transmission destination of the electronic file; an electronic file generation unit that generates the electronic file for displaying the character string represented by the text data received by the first receiving unit on the display screen in accordance with generation information (including information to be set in the electronic document such as how to create and use the electronic document, in addition to information regarding a design of the electronic document) of the electronic document; and a first transmission control unit that transmits information (may be the electronic file or information indicating a reading location of the electronic document) for reading the electronic document represented by the electronic file generated by the electronic file generation unit to the transmission destination represented by the first transmission destination data received by the first receiving unit.

The present invention also provides a method suitable for the electronic file transmission control apparatus. That is, the method comprises: causing a first receiving unit to receive first transmission destination data representing a transmission destination of an electronic file having a file format capable of displaying, on a display screen, an electronic document in which a character string is represented in the same state as a state where the character string is represented on a paper sheet, and text data representing a character string to be transmitted to the transmission destination of the electronic file; causing an electronic file generation unit to generate the electronic file for displaying the character string represented by the text data received by the first receiving unit on the display screen in accordance with generation information of the electronic document; and causing a first transmission control unit to transmit information for reading the electronic document represented by the electronic file generated by the electronic file generation unit to the transmission destination represented by the first transmission destination data received by the first receiving unit.

The present invention also provides a non-transitory tangible recording medium storing a program for controlling a computer of the electronic file transmission control apparatus.

Preferably, the first receiving unit receives, for example, an API call request, and a transmission destination of the electronic file and a character string to be transmitted to the transmission destination are set in the API call request.

Preferably, the first receiving unit receives, for example, an email, a transmission destination of the electronic file is described in a first address of the email, and a character string to be transmitted to the transmission destination is described in a body of the email.

The generation information is stored in a generation information database, and the generation information stored in the generation information database is associated with, for example, a generation information ID for specifying the generation information and an authorized person ID for specifying an authorized person who uses the generation information. In this case, the first receiving unit may receive the generation information ID and authorized person specification information for specifying the authorized person ID. Preferably, the electronic file transmission control device comprises an ID confirmation unit that confirms whether or not the generation information ID received by the first receiving unit and the authorized person ID specified by the authorized person specification information received by the first receiving unit are matched with the generation information ID and the authorized person ID associated with the generation information stored in the generation information database, and the electronic file generation unit generates the electronic file in response to the confirmation of matching by the ID confirmation unit.

The generation information is stored in a generation information database, the generation information stored in the generation information database is associated with, for example, a generation information ID for specifying the generation information and an authorized person ID for specifying an authorized person who uses the generation information, and the authorized person ID is set in the API call request. In this case, the first receiving unit may receive the generation information ID. The electronic file transmission control device may further comprise an ID confirmation unit that confirms whether or not the generation information ID received by the first receiving unit and the authorized person ID described in the API call request are matched with the generation information ID and the authorized person ID associated with the generation information stored in the generation information database, and the electronic file generation unit may generate the electronic file in response to the confirmation of matching by the ID confirmation unit.

The generation information may be stored in a generation information database, the generation information stored in the generation information database may be associated with, for example, a generation information ID for specifying the generation information and an authorized person ID for specifying an authorized person who uses the generation information, and the first receiving unit may receive the generation information ID. Preferably, the electronic file transmission control apparatus comprises an authorized person ID detection unit that detects the authorized person ID based on information obtained from the email received by the first receiving unit, and an ID confirmation unit that confirms whether or not the generation information ID received by the first receiving unit and the authorized person ID detected by the authorized person ID detection unit are matched with the generation information ID and the authorized person ID associated with the generation information stored in the generation information database, and the electronic file generation unit generates the electronic file in response to the confirmation of matching by the ID confirmation unit.

The electronic file transmission control apparatus may comprise a second transmission control unit that transmits the information for reading the electronic document represented by the electronic file generated by the electronic file generation unit to a computer of a confirmer of the electronic file; and a second receiving unit that receives a transmission command from the computer of the confirmer, wherein in response to the reception of the transmission command by the second receiving unit, the information for reading the electronic document represented by the electronic file generated by the electronic file generation unit may be transmitted to the transmission destination represented by the first transmission destination data received by the first receiving unit.

Preferably, the electronic file transmission control apparatus comprises a third transmission control unit that, when information about a confirmer of the electronic file is described in the API call request, transmits the information for reading the electronic document represented by the electronic file generated by the electronic file generation unit to a computer of the confirmer of the electronic file, and a third receiving unit that receives a transmission command from the computer of the confirmer, wherein in response to the reception of the transmission command by the third receiving unit, the information for reading the electronic document represented by the electronic file generated by the electronic file generation unit is transmitted to the transmission destination represented by the first transmission destination data received by the first receiving unit.

Preferably, the electronic file transmission control apparatus comprises a fourth transmission control unit that transmits the information for reading the electronic document represented by the electronic file generated by the electronic file generation unit to a transmission source of the email received by the first receiving unit; and a fourth receiving unit that receives a transmission command from a computer of the transmission source, wherein in response to the reception of the transmission command by the fourth receiving unit, the information for reading the electronic document represented by the electronic file generated by the electronic file generation unit is transmitted to the transmission destination represented by the first transmission destination data received by the first receiving unit.

The first receiving unit may receive a generation information ID for specifying the generation information, and may comprise a generation information search unit that finds the generation information having the generation information ID received by the first receiving unit from a generation information database storing a plurality of pieces of generation information. In this case, the electronic file generation unit preferably generates, for example, the electronic file for displaying the character string represented by the text data received by the first receiving unit on the display screen in accordance with the generation information found by the generation information search unit.

An electronic file transmission control apparatus may comprise: a first receiving unit that receives first transmission destination data representing a transmission destination of an electronic file having a file format capable of displaying, on a display screen, an electronic document in which a character string is represented in the same state as a state where the character string is represented on a paper sheet, and text data representing a character string to be transmitted to the transmission destination of the electronic file; a processor that generates the electronic file for displaying the character string represented by the text data received by the first receiving unit on the display screen in accordance with generation information of the electronic document; and a first transmission control unit that transmits information for reading the electronic document represented by the electronic file generated by the electronic file generation unit to the transmission destination represented by the first transmission destination data received by the first receiving unit.

The information for reading the electronic document is, for example, at least one of the electronic file generated in the electronic file generation unit or information indicating a storage location of the electronic file generated in the electronic file generation unit.

According to the present invention, first transmission destination data representing a transmission destination of an electronic file and text data representing a character string to be transmitted to the transmission destination of the electronic file are transmitted, and the first transmission destination data and the text data are received. An electronic file is generated from the received text data, and information for reading the generated electronic file is transmitted to the transmission destination. A user can transmit information for reading the electronic document represented by the electronic file having a file format such as a PDF file to the desired transmission destination only by transmitting the first transmission destination data and the text data. In particular, when a part of the character string is changed and generated, the user does not need to generate the electronic file each time the character string is changed.

### BRIEF DESCRIPTION OF DRAWINGS

FIG. 1 is a block diagram of an electronic file transmission system.

FIG. 2 is a block diagram illustrating an electrical configuration of a process server.

FIG. 3 is an example of a template.

FIG. 4 is an example of an account table.

FIG. 5 is an example of a user table.

FIG. 6 is an example of an electronic file setting table.

FIG. 7 is an example of an electronic file design table.

FIG. 8 is an example of an email table.

FIG. 9 is an example of a transmission destination table.

FIG. 10 is an example of an email window.

FIG. 11 is an example of an electronic document.

FIG. 12 is a flowchart illustrating a processing procedure of the electronic file transmission system.

FIG. 13 is a flowchart illustrating a processing procedure of the electronic file transmission system.

FIG. 14 is a flowchart illustrating a processing procedure of the electronic file transmission system.

FIG. 15 is a flowchart illustrating a processing procedure of the electronic file transmission system.

FIG. 16 is an example of a web page.

FIG. 17 is an example of a source.

FIG. 18 is an example of a source.

FIG. 19 is an example of an HTTP request.

FIG. 20 is a flowchart illustrating a processing procedure of the electronic file transmission system.

FIG. 21 is an example of content described in a body area of an email.

### DESCRIPTION OF THE PREFERRED EMBODIMENTS

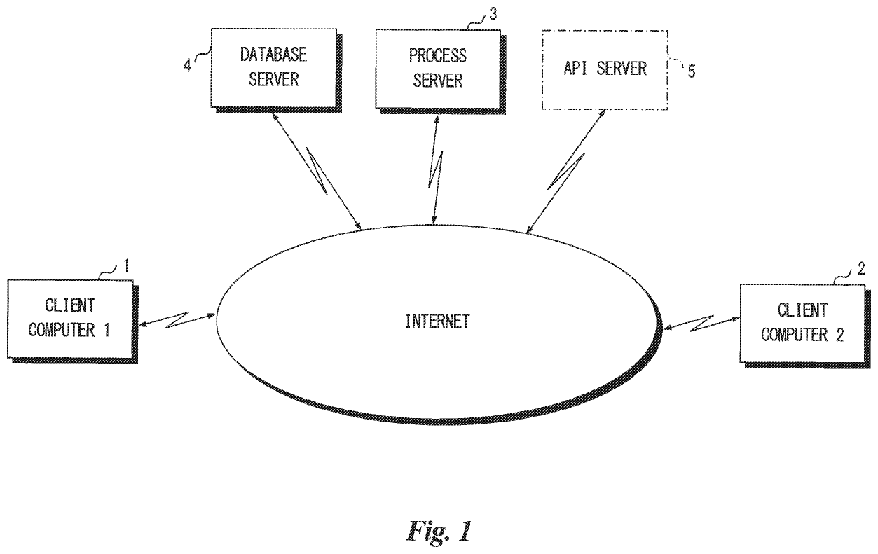

FIG. 1 illustrates an embodiment of the present invention, and illustrates an outline of an electronic file transmission system.

The electronic file transmission system according to the embodiment includes a first client computer 1, a second client computer 2, a process server 3 (which is an example of an electronic file transmission control apparatus), and a database server 4 that can communicate with each other via a network such as the Internet. An API server 5 may be used. The network is not limited to the Internet, and may be an in-house local area network (LAN). In addition, at least one of the client computers 1 and 2 is not limited to a personal computer, and may be a device such as a smartphone or a tablet and may be a device that can perform substantially processing described later by a processor or the like.

In the electronic file transmission system according to the embodiment, an electronic file is transmitted to the second client computer 2 according to the intention of a user of the first client computer 1. The electronic file has a file format such as a portable document format (PDF) file in which an electronic document in which a character string is represented in the same state as a state where a character string is represented on a paper sheet can be displayed on a display screen. In particular, in the embodiment, the user of the first client computer 1 creates a character string, so that processing of converting the character string into an electronic file having the above-described file format is performed in the process server 3. The user of the first client computer 1 can transmit an electronic file having such a file format to the second client computer 2 without performing the processing of conversion into the electronic file.

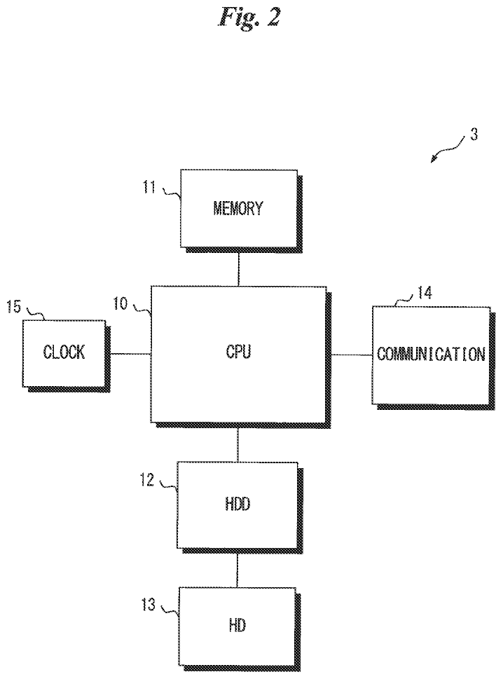

FIG. 2 is a block diagram illustrating an electrical configuration of the process server 3.

The entire processing of the process server 3 is supervised by a central processing unit (CPU) 10.

The process server 3 includes a memory 11 that temporarily stores data and the like, a hard disk 13, a hard disk drive 12 that accesses the hard disk 13, and a communication circuit 14 that communicates with the client computer 1 and the like via the Internet. The process server 3 further includes a clock 15 that measures date and time.

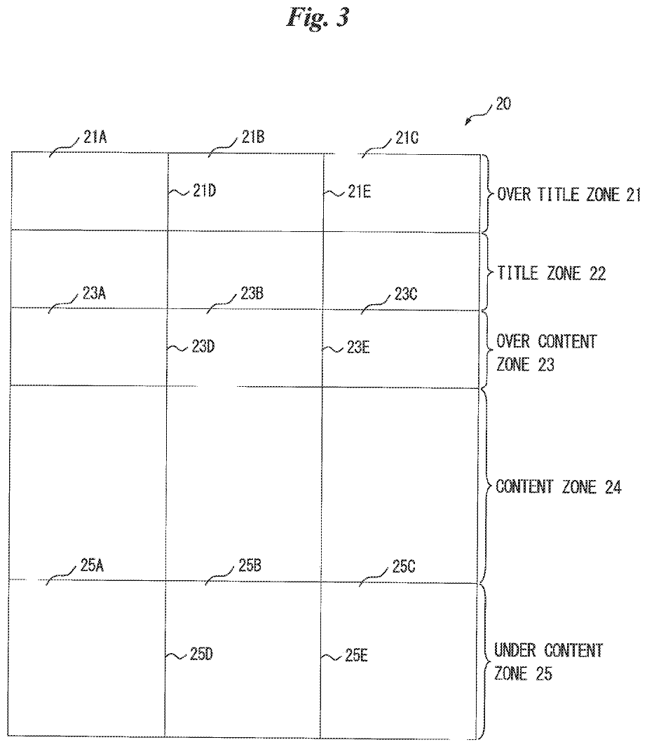

FIG. 3 illustrates an example of a template design of an electronic document displayed on a display screen by the electronic file having the above-described file format.

The user of the first client computer 1 can display and design a template 20 on a display screen of a display device included in the first client computer 1 (users other than the user of the first client computer 1 can design the template in a similar manner).

In the template 20, an over title zone 21 is formed at the top. In addition, a title zone 22 is formed below the over title zone 21, an over content zone 23 is formed below the title zone 22, a content zone 24 is formed below the over content zone 23, and an under content zone 25 is formed below the content zone 24.

The over title zone 21 is a zone for displaying information displayed at the top of a title of an electronic document, and for example, a document number or the like is input by the user so as to be displayed. The over title zone 21 is divided into a left zone 21A, a center zone 21B, and a right zone 21C. Among these zones 21A, 21B, and 21C, desired information is input by the user so as to be displayed in a desired zone. A boundary 21D between the zone 21A and the zone 21B and a boundary 21E between the zone 21B and the zone 21C can be positioned by designation of the user, and the lateral width of each of the zones 21A, 21B, and 21C is defined according to the positions of these boundaries 21D and 21E.

The title zone 22 is a zone for displaying the title of the electronic document. For example, a desired title such as a contract or an admission application is input by the user.

The over content zone 23 is a zone for displaying information displayed at the top of the content zone 24 for displaying content (such as a main sentence) of the electronic document, and for example, a date of issue is input by the user so as to be displayed. Similarly to the over title zone 21, the over content zone 23 is also divided into a left zone 23A, a center zone 23B, and a right zone 23C. A boundary 23D between the zone 23A and the zone 23B and a boundary 23E between the zone 23B and the zone 23C can be positioned by designation of the user, and the lateral width of each of the zones 23A, 23B, and 23C is defined according to the positions of these boundaries 23D and 23E.

The content zone 24 is a zone for displaying content of the electronic document. Desired content (such as a character string to be transmitted to a transmission destination of an electronic file) is input by the user.

The under content zone 25 is a zone for displaying information displayed at the bottom of the content zone 24 for displaying the content (such as the main sentence) of the electronic document, and is defined by the user such that, for example, a signature area or the like is displayed. Similarly to the over content zone 23, the under content zone 25 is also divided into a left zone 25A, a center zone 25B, and a right zone 25C. A boundary 25D between the zone 25A and the zone 25B and a boundary 25E between the zone 25B and the zone 25C can be positioned by designation of the user, and the lateral width of each of the zones 25A, 25B, and 25C is defined according to the positions of these boundaries 25D and 25E.

A boundary between the over title zone 21 and the title zone 22, a boundary between the title zone 22 and the over content zone 23, a boundary between the over content zone 23 and the content zone 24, and a boundary between the content zone 24 and the under content zone 25 may also be configured such that respective positions can be moved by the user to change sizes of the respective zones 21, 22, 23, 24, and 25.

Among these zones 21, 22, 23, 24, and 25, at least the content zone 24 is preferably set as an essential input zone to input a character string to be transmitted to the transmission destination of the electronic file. For example, when the electronic document is a contract, not only the content zone 24 but also the title zone 22, the content zone 24, and any of the zones 25A, 25B and 25C included in the under content zone 25 may be set as essential input zones, and the title of the contract may be designated in the title zone 22, the contract content may be designated in the content zone 24, and the signature position may be designated in the under content zone 25.

Furthermore, the user may be allowed to set a font of the character string displayed on the electronic document, whether the character string is left-aligned, center-aligned, or right-aligned, or the like.

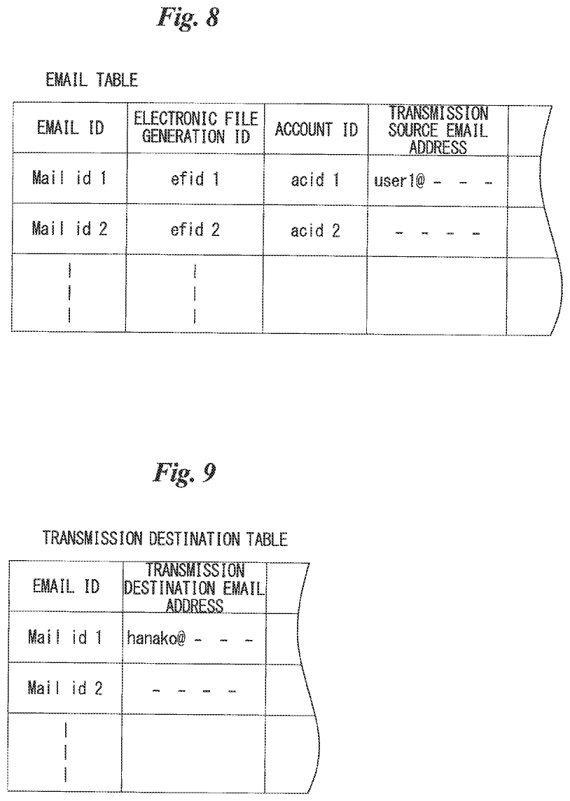

FIGS. 4 to 9 are examples of tables stored in the database server 4. Information stored in the tables illustrated in FIGS. 4 to 7 among the tables illustrated in FIGS. 4 to 9 is stored in advance before the electronic file transmission system is used. Information stored in the tables illustrated in FIGS. 8 and 9 is stored in response to reception of an email by the process server 3.

FIG. 4 is an example of an account table.

In the electronic file transmission system, a user is registered in advance. The member registration can be registered as an individual user, but can also be registered as an organization such as a company. An account table stores information about an account for a company organization (or an individual user).

In the account table, an account name (organization name), a telephone number (a telephone number of a contact address of the organization), and the like are stored corresponding to an account ID. The account ID is issued by an operating company or the like of the electronic file transmission system at the time of the member registration.

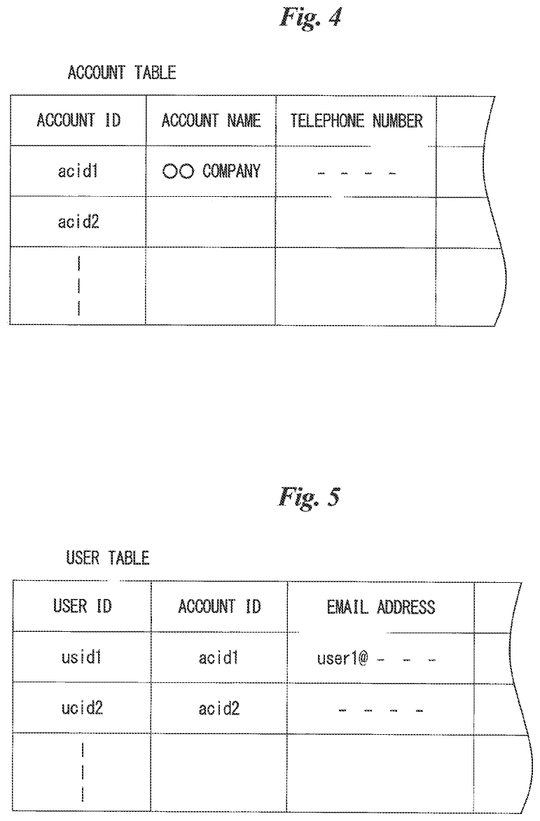

FIG. 5 is an example of a user table.

The user table stores information about an individual user. In the user table, an account ID assigned to an organization to which the user belongs, an email address of an individual user, and the like are stored corresponding to the user ID.

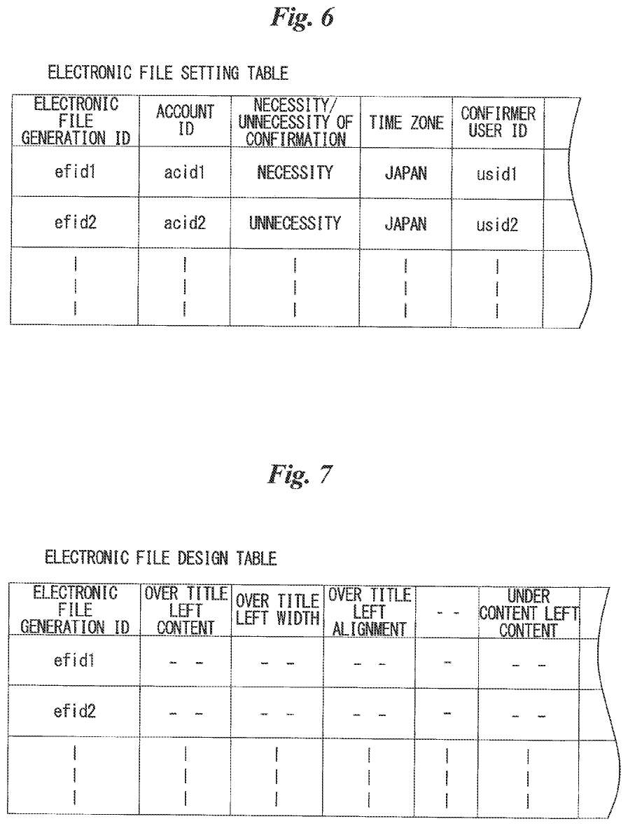

FIG. 6 is an example of an electronic file setting table.

The electronic file setting table (which is an example of a generation information database) stores setting information (which is an example of generation information of an electronic document) regarding a use method, a creation method, and the like of the electronic document.

In the electronic file setting table, information such as an account ID (an example of an authorized person ID), necessity/unnecessity of confirmation, a time zone, and a confirmer user ID is stored corresponding to an electronic file generation ID (an example of a generation information ID). As will be described in detail later, the electronic file generation ID is generated when the use method of the electronic document and the design of the electronic document illustrated in FIG. 3 are designated by the user. The account ID associated with a user ID of a user who has set the use method of the electronic document or the like is read from the user table and stored in the electronic file setting table. The information about the necessity/unnecessity of the confirmation is information about whether or not it is necessary to confirm the electronic document represented by the generated electronic file as described later. For example, the information about the necessity/unnecessity of the confirmation is information about whether or not a user of the first client computer 1 who intends to send the generated electronic file to the second client computer 2 needs to confirm the electronic document. The time zone is information about which time zone a standard time to be used is set to when information about a date such as a date of issue is automatically assigned to the electronic document according to the clock 15 included in the process server 3. The confirmer user ID is a user ID of a confirmer in a case of confirming the electronic document represented by the generated electronic file.

FIG. 7 is an example of an electronic file design table.

As described with reference to FIG. 3, the electronic file design table (which is an example of the generation information database) stores information about the design of the electronic document set by the user (which is an example of the generation information of the electronic document).

In the electronic file design table, information regarding the design set by the user using the template 20 of FIG. 3, such as over title left content (content included in the left zone 21A of the over title zone 21), over title left width (width of the left zone 21A of the over title zone 21), and over title left alignment (whether content included in the left zone 21A of the over title zone 21 is left-aligned, center-aligned, or right-aligned), is stored corresponding to an electronic file generation ID.

FIG. 8 is an example of an email table.

The email table stores information regarding an email transmitted from the user.

In the email table, information such as an electronic file generation ID, an account ID, and a transmission source email address is stored corresponding to an email ID. As described later, the email ID is issued in response to reception of the email transmitted from the user in the process server 3, and the issued email ID is stored in the email table.

FIG. 9 is an example of a transmission destination table.

The transmission destination table stores information about a transmission destination of an email. An email address of the transmission destination is stored corresponding to the email ID.

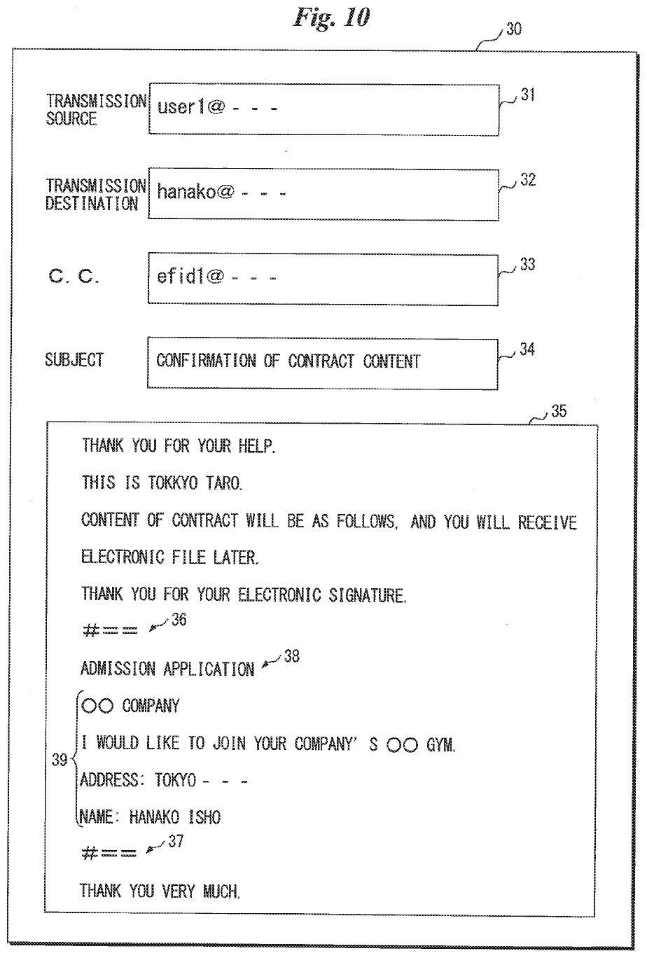

FIG. 10 is an example of an email window illustrating content of an email transmitted from the first client computer 1 to the second client computer 2.

When email software is started and a new email is transmitted, an email window 30 is displayed on a display screen of a display device of the first client computer 1.

In the email window 30, a transmission source address input area 31 for inputting an address of a transmission source of the email, a transmission destination address input area 32 for inputting an address of a transmission destination of the email, a cc address input area 33 for inputting an address of a transmission destination of a copy of the email, a subject input area 34 for inputting a subject of the email, and a body input area 35 for inputting a body of the email are formed.

In the embodiment, an email address of the user of the first client computer 1 is input to the transmission source address input area 31. An email address of the user of the second client computer 2 to be the transmission destination of the email is input to the transmission destination address input area 32 (which is an example of an area for inputting a first address). An electronic file generation ID of the user is described in a portion before the @ sign in the email address to be input to the cc address input area 33. A predetermined domain name is described in a portion after the @ sign in the email address to be input to the cc address input area 33 so that the email is transmitted to the process server 3.

In the body input area 35, a title 38 and content 39 to be described in an electronic document and transmitted to the user of the second client computer 2 are input so as to be sandwiched between reflection portion identification marks 36 and 37. The user of the first client computer 1 inputs the reflection portion identification marks 36 and 37 and inputs the title 38 and the content 39 between these reflection portion identification marks 36 and 37.

In the embodiment, in the template 20 illustrated in FIG. 3, the title zone 22, the content zone 24, and the right zone 25C of the under content zone 25 are essential zones, a title is input to the title zone 22, a character string representing content is input to the content zone 24, and a position where signature is written is defined in the right zone 25C of the under content zone 25.

In FIG. 10, one row after the reflection portion identification mark 36 is defined as the title 38 (which is an example of text represented by the text data received by the first receiving unit, and is an example of a character string to be transmitted to the transmission destination of the electronic file), and a row after the title 38 to a row before the reflection portion identification mark 37 are defined as positions where the content 39 (which is an example of a text represented by the text data received by the first receiving unit, and is an example of a character string to be transmitted to the transmission destination of the electronic file) is input. A sentence before the reflection portion identification mark 36 and a sentence after the reflection portion identification mark 37 are to be transmitted to the user of the second client computer 2 as sentences of the email and are not reflected in the electronic document. In the embodiment, since the title zone 22, the content zone 24, and the right zone 25C of the under content zone 25 is an essential zone in the template 20 illustrated in FIG. 3, one row after the reflection portion identification mark 36 is defined as the title 38, and the row after the title 38 to the row before the reflection portion identification mark 37 are defined as the positions where the content 39 is input. However, according to the design of the template 20, positions in the electronic document where the character strings described between the reflection portion identification marks 36 and 37 are displayed change. For example, in the template 20, if the title zone 22 is not essential and only the content zone 24 is essential, the character strings described between the reflection portion identification marks 36 and 37 are all displayed at positions corresponding to the content zone 24 in the electronic document. Identification marks corresponding to the respective zones among the zones 21 to 25 (including the zones 21A to 21C, the zones 23A to 23C, and the zones 25A to 25C) are defined, and character strings input corresponding to the identification marks are discriminated, so that it is possible to know in which zone among the zones 21 to 25 (including the zones 21A to 21C, the zones 23A to 23C, and the zones 25A to 25C) the input character string is to be arranged.

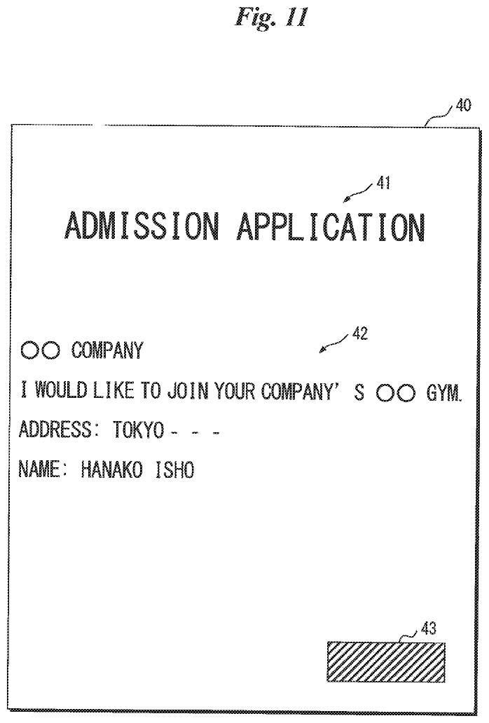

FIG. 11 is an example of an electronic document generated in the process server 3 by transmitting the email illustrated in FIG. 10.

In the electronic document 40, a title 41 of “admission application”, content 42 of the electronic document 40, and a signature area 43 in which the signature is written are displayed.

An electronic file generation ID is specified by a character string described before the @ sign in the cc address input area 33 of the email. Information corresponding to the specified electronic file generation ID is read from the electronic file setting table illustrated in FIG. 6 and the electronic file design table illustrated in FIG. 7, and the use method, the creation method, the design, and the like of the electronic document are determined.

In the electronic document 40 illustrated in FIG. 11, the information corresponding to the designated electronic file generation ID is read from the electronic file design table such that there is no information to be described in the over title zone 21 illustrated in FIG. 3, the character string of the title displayed in the title zone 22 is center-aligned, the character string of the content displayed in the content zone 24 is left-aligned, and the signature area 43 is displayed in the right zone 25C of the under content zone 25. As a result, the email illustrated in FIG. 10 is transmitted, so that an electronic document 40 having a design illustrated in FIG. 11 is generated.

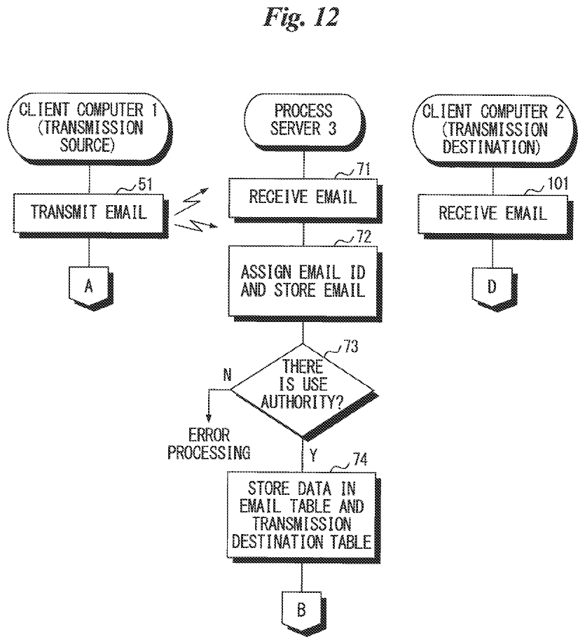

FIGS. 12 to 14 are flowcharts illustrating a processing procedure of the electronic file transmission system.

In the embodiment, when an email with the content illustrated in FIG. 10 is transmitted, the electronic file is transmitted to the second client computer 2, and the electronic document 40 illustrated in FIG. 11 is displayed on the display screen of the display device of the second client computer 2. In the embodiment, although the email is transmitted from the user of the first client computer 1, the email may be transmitted from a user other than the user of the first client computer 1, or the transmission source may be a computer such as a server instead of a person.

The user of the first client computer 1 inputs his/her email address in the transmission source address input area 31 of the email window 30 illustrated in FIG. 10 (it may be automatically input). An email address of the user of the second client computer 2 to be the transmission destination is input to the transmission destination address input area 32. An email address where a portion before the @ sign is an electronic file generation ID for identifying the design or the like of the electronic document created by the user, and a portion after the @ sign is a domain name for transmitting an email to the process server 3 is input to the cc address input area 33. A subject of the email is input to the subject input area 34, and a character string to be transmitted to the user of the second client computer 2 is input to the body input area 35. In particular, in the body input area 35, the user inputs a character string such that the sentence to be reflected in the electronic document is sandwiched between the reflection portion identification marks 36 and 37 as described above.

When a transmission command for the email generated as described above is given to email software installed in the first client computer 1, the email is transmitted to the second client computer 2 and the process server 3 via an email server (not illustrated in the drawings) (step 51 in FIG. 12).

When the email is received at the second client computer 2 (step 101 in FIG. 12) and the user of the second client computer 2 confirms the received email, the user knows that the electronic document 40 illustrated in FIG. 11 is later transmitted as an attachment to the email.

When the email is also received in the communication circuit 14 (which is an example of a first receiving unit) of the process server 3 (step 71 in FIG. 12), the process server 3 assigns an email ID to the received email, and stores the received email and the email ID in association with each other in the database server 4 (may be stored in another server, a file system, or the like) (step 72 in FIG. 12). Subsequently, the process server 3 confirms whether or not the user of the first client computer 1 has authority to use setting information regarding the use method, the creation method, and the like of the electronic document, a creation method, and the like (step 73 in FIG. 12). The presence or absence of the use authority can be determined as follows. The electronic file generation ID can be known from the email address described in the cc address input area 33 of the email. When the electronic file generation ID is known, the account ID is known from the electronic file setting table illustrated in FIG. 6. When the account ID is known, the user ID corresponding to the account ID can be extracted from the user table illustrated in FIG. 5. When the email address (transmission source email address) of the user of the first client computer 1 is matched with any of the email addresses corresponding to the extracted user ID, it is determined that the user of the first client computer 1 has authority to use the setting information regarding the use method, the creation method, and the like of the electronic document. When it is determined that the user does not have the use authority (NO in step 73 in FIG. 12), predetermined error processing is performed. When it is determined that the user has the use authority (YES in step 73 in FIG. 12), the procedure proceeds to next processing.

Subsequently, the process server 3 accesses the database server 4 and stores the electronic file generation ID, the account ID, the transmission source email address, and the like corresponding to the assigned email ID in the email table (see FIG. 8) stored in the database server 4 (step 74 in FIG. 12). Further, the transmission destination email address is stored in the transmission destination table (see FIG. 9).

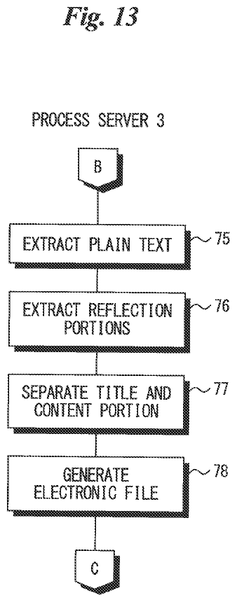

When the email stored in the database server 4 is read and the email (text data representing the email) has a multipart format, a plain text portion is extracted by the CPU 10 of the process server 3 (step 75 in FIG. 13). Subsequently, reflection portions in the electronic document (character strings to be transmitted) sandwiched between the reflection portion identification marks 36 and 37 are extracted from the plain text portion by the CPU 10 of the process server 3 (step 76 in FIG. 13). In the example illustrated in FIG. 10, the reflection portions are the title 38 and the content 39.

Further, the title and the content portion are separated from the extracted reflection portions by the CPU 10 of the process server 3 (step 77 in FIG. 13). In the extracted reflection portions, a portion corresponding to the first row is the title, and the remaining portion is the content portion. When the title and the content portion are obtained in this way, information of the use method, the design, and the like of the electronic document corresponding to the electronic file generation ID described before the @ sign in the cc address input area 33 of the email is read from the electronic file setting table illustrated in FIG. 6 and the electronic file design table illustrated in FIG. 7 by the CPU 10 (which is an example of a generation information search unit). An electronic file representing the electronic document having the design based on the read information and created by the creation method based on the read information is generated by the CPU 10 (which is an example of an electronic file generation unit) of the process server 3 (step 78 in FIG. 13).

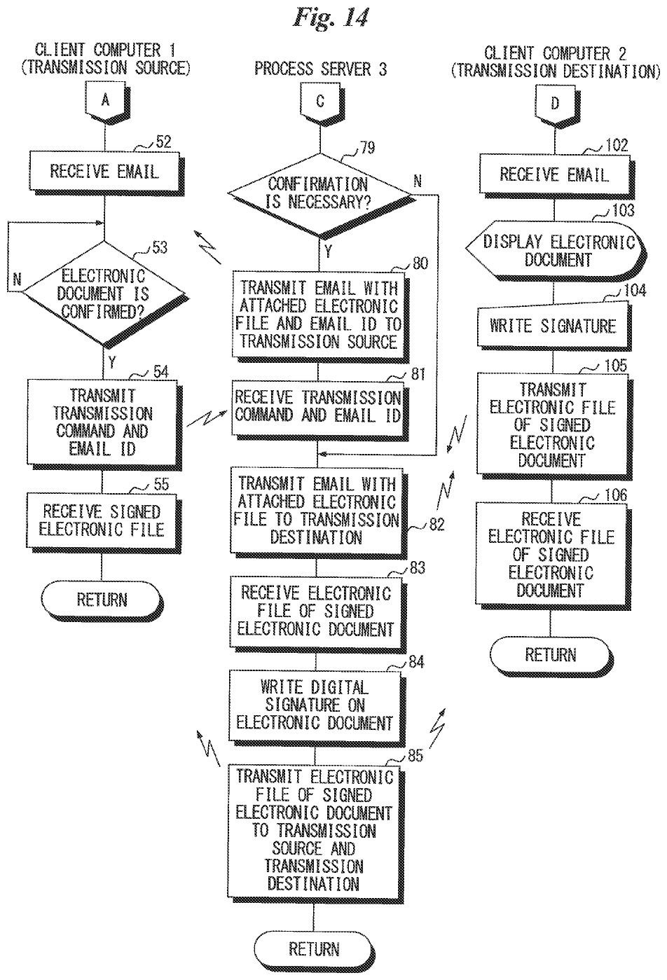

Subsequently, the CPU 10 of the process server 3 confirms whether or not it is necessary to confirm the electronic document represented by the generated electronic file (step 79 in FIG. 14).

With reference to the electronic file setting table illustrated in FIG. 6, it is determined that the confirmation is necessary when the information regarding the necessity/unnecessity of the confirmation stored corresponding the electronic file generation ID is “necessity” (YES in step 79 in FIG. 14). An email to which the generated electronic file has been attached is generated by the CPU 10 of the process server 3.

In order to confirm the electronic document 40, the email to which the electronic file has been attached is transmitted together with the email ID to the email address specified by the confirmer user ID in the electronic file setting table illustrated in FIG. 6 (or the user of the first client computer 1) by the communication circuit 14 under the control of the CPU 10 (which is an example of each of a second transmission control unit and a fourth transmission control unit) (step 80 in FIG. 14). In the embodiment, it is assumed that the email is sent to the user of the first client computer 1. Together with the email ID generated when the email is transmitted from the user of the first client computer 1, the email is transmitted to the user of the first client computer 1 by the communication circuit 14 under the control of the CPU 10 (which is an example of the second transmission control unit) (step 80 in FIG. 14).

With reference to the electronic file setting table illustrated in FIG. 6, it is determined that the confirmation is unnecessary when the information regarding the necessity/unnecessity of the confirmation stored corresponding to the electronic file generation ID is “unnecessity” (NO in step 79 in FIG. 14), and the processing of steps 80 and 81 is skipped.

When the email transmitted from the process server 3 is received at the first client computer 1 (step 52 in FIG. 14), the electronic document represented by the electronic file attached to the received email is confirmed by the user of the first client computer 1. When the user performs confirmation and determines that the electronic file generated in the process server 3 may be transmitted to the user of the second client computer 2 (YES in step 53 of FIG. 14), a transmission command and an email ID are transmitted from the first client computer 1 to the process server 3 based on a user's instruction (step 54 in FIG. 14). For example, the transmission command may be transmitted by clicking a uniform resource locator (URL) link where an email ID becomes a parameter.

When the transmission command and the email ID transmitted from the first client computer 1 are received at the communication circuit 14 (which is an example of each of the second receiving unit and the fourth receiving unit) of the process server 3 (step 81 in FIG. 14), the email address of the user of the second client computer 2 to be the transmission destination is known from the email ID. An email requesting the user of the second client computer 2 to write signature on the electronic document is generated, and the electronic file is attached to the generated email. The email to which the electronic file has been attached is transmitted from the CPU 10 (which is an example of a first transmission control unit) of the process server 3 to the user of the second client computer 2 (step 82). Even when it is determined that the confirmation is unnecessary (NO in step 79 of FIG. 14), the email to which the generated electronic file has been attached is transmitted from the process server 3 to the client computer 2 (step 82).

When the email transmitted from the process server 3 is received at the second client computer 2 (step 102 in FIG. 14), the electronic document 40 represented by the electronic file attached to the received email is displayed on the display screen of the display device of the second client computer 2 (step 103 in FIG. 14). The user of the second client computer 2 looks at the displayed electronic document and writes signature in the signature area 43 (step 104 in FIG. 14). When the signature is written, the user of the second client computer 2 attaches an electronic file representing the electronic document 40 on which the signature has been written to the email. A file name of the attached electronic file preferably includes an email ID. When a send button (not illustrated in the drawings) of the email is pressed, the email to which the electronic file has been attached is transmitted from the second client computer 2 to the process server 3 via the email server (step 105 in FIG. 14).

When the electronic file representing the electronic document 40 on which the signature has been written is received at the process server 3 (step 83 in FIG. 14), digital signature is written on the electronic document 40 at the process server 3 (step 84 in FIG. 14). The electronic file representing the electronic document on which the digital signature has been written is transmitted from the process server 3 to each of the first client computer 1 and the second client computer 2 as an attachment to an email (step 85 in FIG. 14).

The electronic file representing the electronic document on which the digital signature has been written is received at each of the first client computer 1 and the second client computer 2 (steps 55 and 106 in FIG. 14).

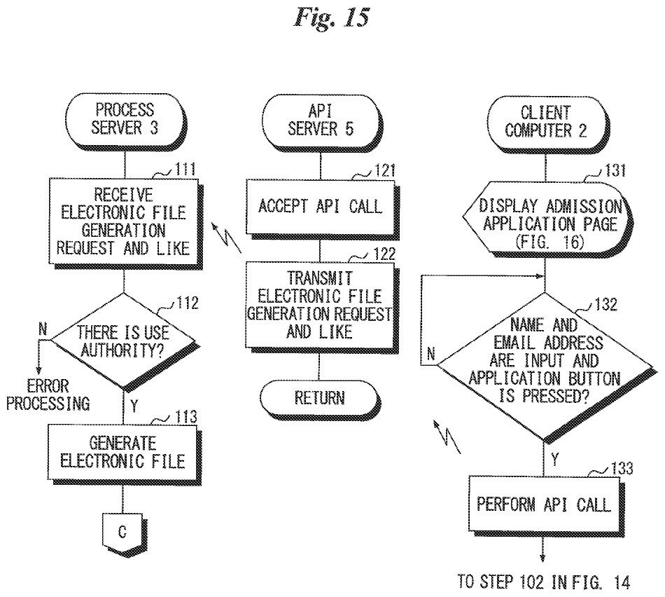

FIGS. 15 to 19 illustrate another embodiment in which the electronic document 40 illustrated in FIG. 11 is generated using an application programming interface (API).

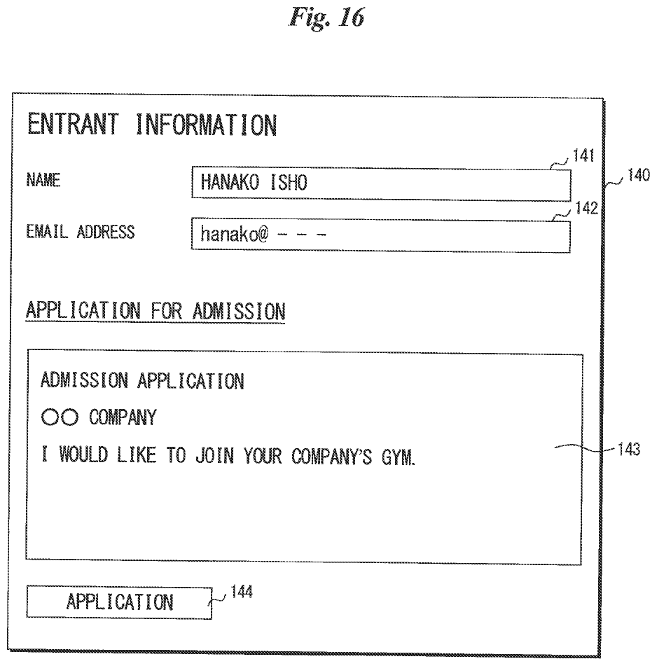

The user of the second client computer 2 accesses a web page of a predetermined uniform resource locator (URL). Then, a web page 140 illustrated in FIG. 16 is displayed on the display screen of the display device of the second client computer 2 (step 131 in FIG. 15).

Referring to FIG. 16, the web page 140 is a web page for applying for admission. In the web page 140, a name input area 141 for inputting a name of a person who applies for admission after a character string of “name”, an email address input area 142 for inputting an email address of the person who applies for admission after a character string of “email address”, a content display area 143 for inputting and displaying content of application, and an application button 144 for displaying a character string of “application” are formed.

In the content display area 143, character strings of “admission application”, “Go company”, and “I would like to join your company's gym.” are displayed in advance.

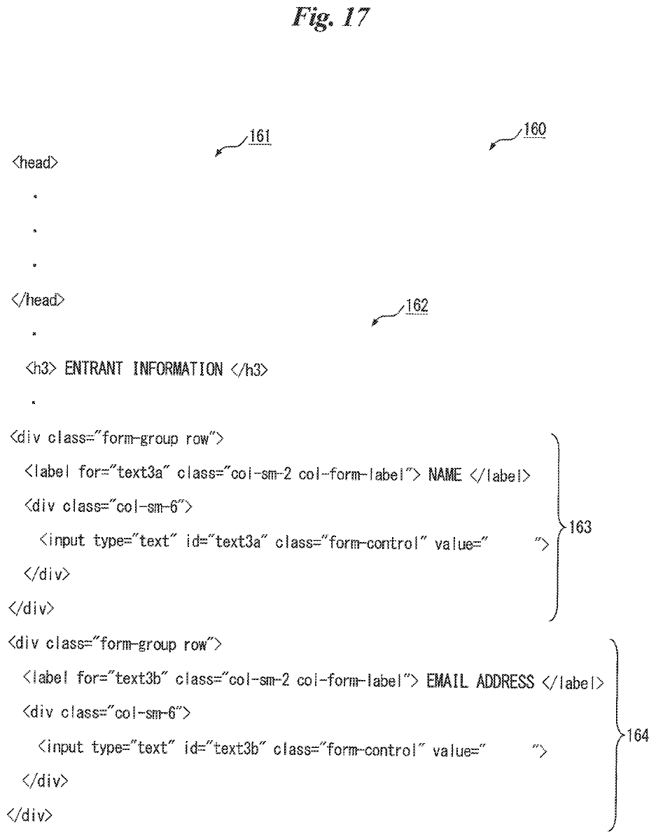

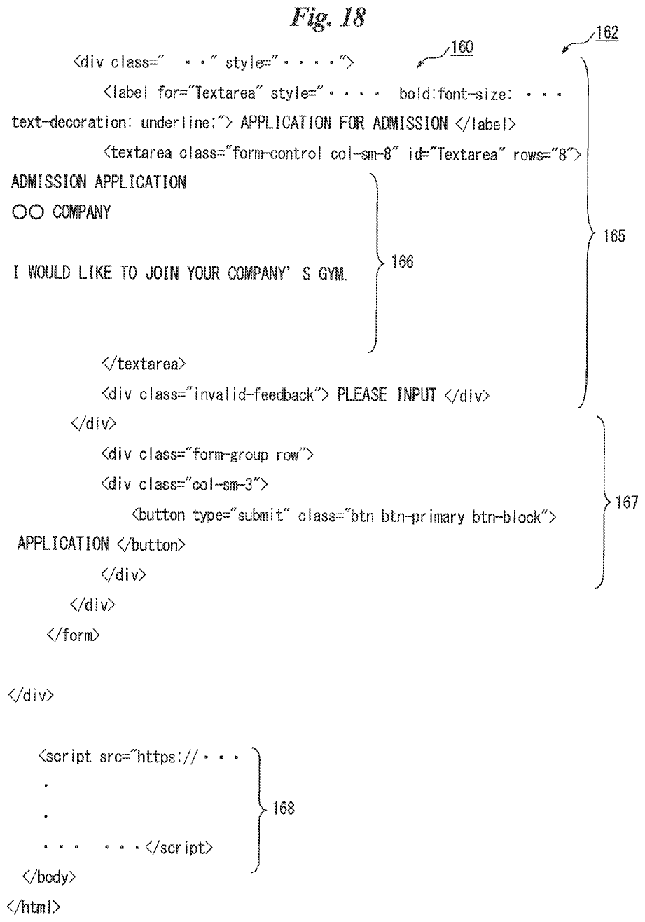

FIGS. 17 and 18 illustrate a portion of a source 160 for displaying the web page 140 illustrated in FIG. 16.

The source 160 includes a header 161 and a body 162.

The body 162 illustrated in FIG. 17 includes a portion 163 that displays the name input area 141 of the web page 140 and the character string of “name” displayed before the area 141, and a portion 164 that displays the email address input area 142 of the web page 140 and the character string of “email address” displayed before the area 142.

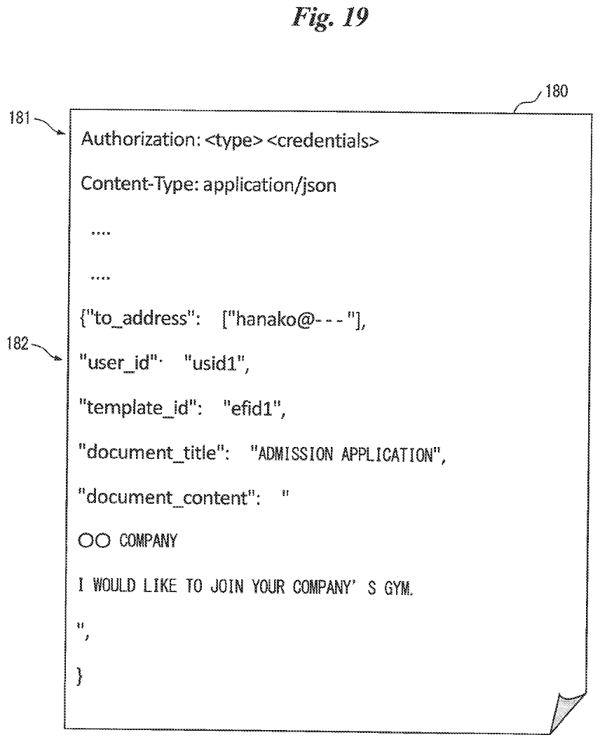

The body 162 illustrated in FIG. 18 includes a portion 165 that displays the content display area 143. The portion 165 includes a portion 166 that represents character strings to be displayed in the content display area 143. In addition, the body 162 illustrated in FIG. 18 includes a portion 167 that displays the application button 144 and a portion 168 that represents processing of reading a script file stored outside and generating an HTTP request 180 illustrated in FIG. 19, when the application button 144 is pressed.

Returning to FIG. 15, the user of the second client computer 2 confirms the content displayed in the content display area 143, inputs his/her name to the name input area 141, and inputs his/her email address to the email address input area 142. These name and email address may be input in advance. When the application button 144 is pressed (YES in step 132 of FIG. 15), an API call is performed, and a hypertext transfer protocol (HTTP) request (which is an example of an API call request) 180 illustrated in FIG. 19 is generated. The generated HTTP request 180 is transmitted from the client computer 2 to the API server 5 (step 133 in FIG. 15).

Referring to FIG. 19, the HTTP request 180 includes a header 181 and a body 182. In a first row (to address) of the body 182, an email address of the user of the second client computer 2 to be the transmission destination of the electronic file is described. In a second row (user id) of the body 182, a user ID (which is an example of an authorized person ID) of the first client computer 1 is described. In a third row (template) of the body 182, an electronic file generation ID (which is an example of a generation information ID) is described. In a fourth row (document title) of the body 182, the title 41 of the electronic document 40 is described. After a fifth row (document content) of the body 182, the content 42 (which is an example of a character string to be transmitted to the transmission destination) of the electronic document 40 is described. Instead of the user ID, an account ID (which is an example of an authorized person ID) may be described (or, the account ID may be added to the user ID), and the presence or absence of the use authority may be determined as described later using the account ID, similarly to the embodiment for the email.

The user ID of the first client computer 1 described in the second row (user id) of the body 182, the electronic file generation ID described in the third row (template) of the body 182, and the title 41 of the electronic document 40 described in the fourth row (document title) of the body 182 may be described in the source 160 illustrated in FIGS. 17 and 18, or may be stored and read in another storage location (for example, a predetermined storage area of a storage server). In any case, these pieces of information are read and the HTTP request 180 is generated.

When the API server 5 accepts an API call and receives the HTTP request 180 (step 121 in FIG. 15), the HTTP request 180 (or a call other than the HTTP request) and a request for generating an electronic file are transmitted the API server 5 to the process server 3 (step 122 in FIG. 15).

When the HTTP request 180 and the electronic file generation request are received in the process server 3 (step 111 in FIG. 15), the CPU 10 (which is an example of an ID confirmation unit) of the process server 3 confirms whether or not there is authority to use the setting information regarding the use method, the creation method, and the like of the electronic document, from the user ID and the electronic file generation ID described in the body 182 of the HTTP request 180 (step 112 in FIG. 15). The account ID corresponding to the user ID can be known from the user table illustrated in FIG. 5. When the electronic file generation ID described in the HTTP request 180 is known, the account ID is obtained from the electronic file setting table illustrated in FIG. 6. When the obtained account ID is the same as the account ID obtained from the user table, it is confirmed that there is authority to use the setting information. Even in this case, a password may be used to confirm whether or not there is use authority. It is preferable that the user ID and the electronic file generation ID are not described in the source 160 illustrated in FIGS. 17 and 18. In this case, the HTTP request in which the user ID and the electronic file generation ID are excluded is generated in the client computer 2, the generated HTTP request is transmitted to a server (such as a WEB server) of a company to which the user of the first client computer 1 belongs, an HTTP request including the user ID and the electronic file generation ID is generated in the server (such as the WEB server) of the company, and the generated HTTP request is transmitted to the API server 5. The electronic file generation request and the like are transmitted from the API server 5 to the process server 3 as described above. It is possible to more firmly prevent leakage of the user ID and the electronic file generation ID to a third party.

When it is confirmed that there is use authority (YES in step 112 of FIG. 15), the electronic file representing the electronic document 40 according to the setting information stored in the electronic file setting table illustrated in FIG. 6 and the design information stored in the electronic file design table illustrated in FIG. 7 is generated in the process server 3, and the document ID is issued and associated with the generated electronic file (step 113 in FIG. 15). From the document ID and the content of the HTTP request 180, the process server 3 generates document table data in which the document ID is stored instead of the email ID in the email table illustrated in FIG. 8 and transmission destination table data in which the document ID is stored instead of the email ID in the transmission destination table illustrated in FIG. 9. Thereafter, the processing is similar to the case where the document ID is used instead of the email ID in the processing after step 79 in FIG. 14.

In a case of confirming the electronic document 40 represented by the generated electronic file, the account ID is known from the user ID (which is an example of confirmer information) described in the HTTP request 180 illustrated in FIG. 19, and the confirmer user ID is known. The electronic file generated for confirmation in the email address corresponding to the confirmer user ID is transmitted to the CPU 10 (which is an example of a third transmission control unit) of the process server 3. When the communication circuit 14 (which is an example of a third receiving unit) of the process server 3 receives the transmission command from the confirmer, the electronic file is transmitted to the second client computer 2 as described above.

When the user of the first client computer 1 needs to confirm the content of the electronic document (YES in step 79 of FIG. 14), an email to which an electronic file has been attached and an email ID are sent to the user of the first client computer 1, but the email address of the user is known from the user table illustrated in FIG. 5.

By changing the portion 166 of the source 160 illustrated in FIG. 18, an electronic file representing the electronic document 40 with the changed content is generated, and the generated electronic file can be transmitted to the user of the second client computer 2. In the embodiment described above, the portion 166 representing the character strings to be displayed in the content display area 143 of the web page 140 is described in the source 160 illustrated in FIGS. 17 and 18. However, when the character strings are not displayed in the content display area 143 of the web page 140, the character strings may be described in a non-display area of the source 160. Further, a script file may be read from the source 160 and the character strings may be described in the script file, or the script file read from the source 160 may further call the character strings.

In the embodiment described above, the electronic document 40 illustrated in FIG. 11 is generated. However, various types of electronic documents can be generated by changing not only such document but also the template illustrated in FIG. 3, the setting information stored in the electronic file setting table illustrated in FIG. 6, the design information stored in the electronic file design table illustrated in FIG. 7, and the like.

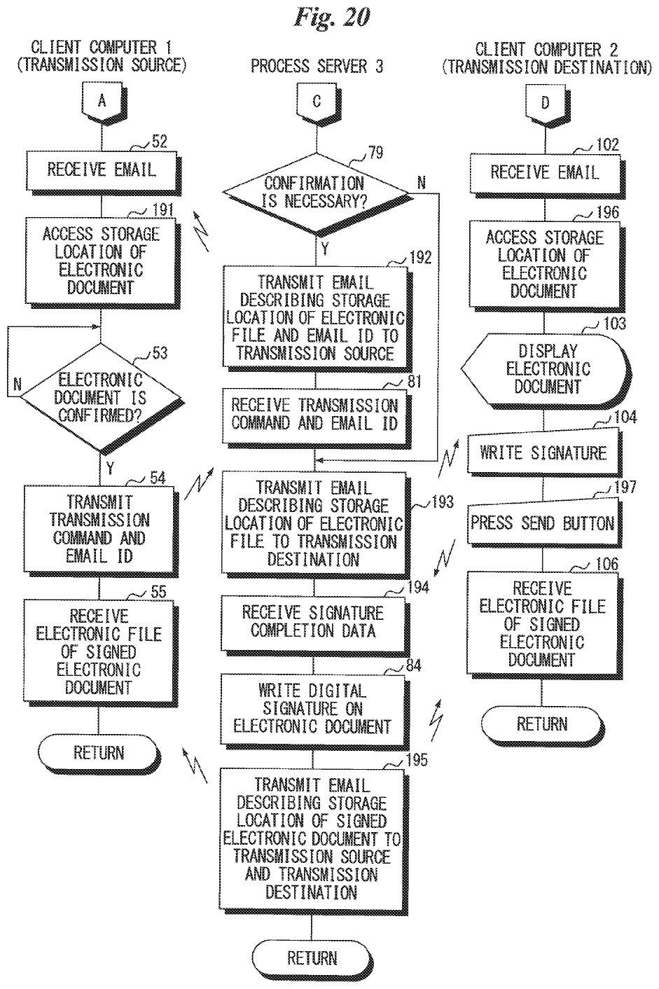

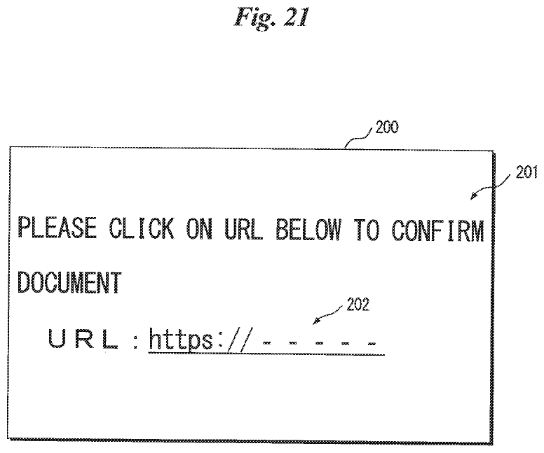

FIGS. 20 and 21 illustrate another embodiment.

In the embodiment described above, an electronic file representing the electronic document 40 is transmitted to the user of the first client computer 1, the user of the second client computer 2, and the like. However, in this embodiment, information indicating a storage location of such an electronic file is transmitted by an email.

FIG. 20 is a flowchart illustrating a part of a processing procedure of an electronic file transmission system, and corresponds to the processing procedure of FIG. 14. In FIG. 20, the same processing as the processing in FIG. 14 is denoted by the same reference numeral, and description thereof is omitted.

As described above, in a case where an electronic file representing the electronic document 40 is generated in the process server 3 and it is necessary to confirm the electronic document 40 (YES in step 79), an email describing a storage location of the electronic file and an email ID (as described above, it is an email ID issued when an email transmitted from the first client computer 1 is received; refer to step 72 in FIG. 12) are transmitted to the first client computer 1 (step 192).

In the first client computer 1, when an email or the like transmitted from the process server 3 is received (step 52), the user of the first client computer 1 accesses a storage location described in the received email (step 191), and acquires an electronic file. When the user of the first client computer 1 confirms an electronic document represented by the acquired electronic file (YES in step 52), a transmission command is transmitted from the first client computer 1 to the process server 3 (step 54).

FIG. 21 is an example of an email transmitted from the process server 3 to the first client computer 1.

In a body area 200 of an email window, a character string 201 of “Please click on a URL below to confirm a document.” and a character string 202 of the URL are displayed. The character string 202 of the URL is a clickable. When the character string 202 of the URL is clicked by the user of the first client computer 1, the area storing the generated electronic file is accessed, and the user of the first client computer 1 can read and confirm the electronic document represented by the electronic file.

Returning to FIG. 20, when the transmission command from the first client computer 1 is received at the process server 3 (step 81), an email describing the storage location of the electronic file is transmitted from the process server 3 to the second client computer 2 to be the transmission destination of the electronic file (step 193).

When the second client computer 2 receives the email transmitted from the process server 3 (the email transmitted via the email server) (step 102), the user of the second client computer 2 accesses the storage location of the electronic file described in the received email (step 196). A web page on which the electronic document illustrated in FIG. 11 is displayed is displayed on the display screen of the display device of the second client computer 2 (step 103). The user of the second client computer 2 writes signature in the signature area 43 of the electronic document 40 displayed on the web page (step 104). The same document as the electronic document 40 may be displayed on the web page, or a pseudo document that can be regarded as the same document as the electronic document 40 may be displayed. In any case, it is sufficient that the content of the electronic document 40 can be confirmed by the user of the second client computer 2 and signature can be input. A send button (not illustrated in the drawings) is formed on the web page, and when the send button is pressed by the user of the second client computer 2 (step 197), signature completion data is transmitted from the second client computer 2 to the process server 3.

When the signature completion data is received at the process server 3 (step 194), digital signature is written on the electronic document 40 at the process server 3 (step 84), and an email describing the storage location of the electronic file representing the electronic document 40 on which the digital signature has been written is transmitted to each of the first client computer 1 and the second client computer 2 (step 195). The electronic document 40 on which the digital signature has been written can be obtained by each of the user of the first client computer 1 and the user of the second client computer 2.

The embodiment illustrated in FIGS. 20 and 21 is applied to the email, but can also be applied to the API call as illustrated in FIGS. 15 to 19.

In addition to the CPU that executes software to function as various processing units, the processing unit that executes the above-described processing includes a programmable logic device that can change a circuit configuration after manufacturing, such as a field-programmable gate array (FPGA), a dedicated electric circuit that is a processor having a circuit configuration specifically designed for executing specific processing, such as an application specific integrated circuit (ASIC), and the like.

One processing unit may be configured by one of these various processors, or may be configured by a combination of two or more processors of the same type or different types (for example, a combination of a plurality of FPGAs or a combination of a CPU and an FPGA). As an example in which a plurality of processing units are configured by one processor, first, as represented by a computer such as a client computer or a server, there is a form in which one processor is configured by a combination of one or more CPUs and software, and this processor functions as the plurality of processing units. Second, as represented by a system-on-chip or the like, there is a form of using a processor that realizes a function of the entire system including the plurality of processing units with one integrated circuit (IC) chip. As described above, the various processing units are configured using one or more of various processors as a hardware structure.

Furthermore, the hardware structure of these various processors is more specifically an electric circuit in which circuit elements such as semiconductor elements are combined.

1. An electronic file transmission control apparatus comprising:
a first receiving unit that receives first transmission destination data representing a transmission destination of an electronic file having a file format capable of displaying, on a display screen, an electronic document in which a character string is represented in the same state as a state where the character string is represented on a paper sheet, and text data representing a character string to be transmitted to the transmission destination of the electronic file;
an electronic file generation unit that generates the electronic file for displaying the character string represented by the text data received by the first receiving unit on the display screen in accordance with generation information of the electronic document; and
a first transmission control unit that transmits information for reading the electronic document represented by the electronic file generated by the electronic file generation unit to the transmission destination represented by the first transmission destination data received by the first receiving unit.

2. The electronic file transmission control apparatus according to claim 1, wherein
the first receiving unit receives an API call request, and
a transmission destination of the electronic file and a character string to be transmitted to the transmission destination are described in the API call request.

3. The electronic file transmission control apparatus according to claim 1, wherein
the first receiving unit receives an email,
a transmission destination of the electronic file is described in a first address of the email, and
a character string to be transmitted to the transmission destination is described in a body of the email.

4. The electronic file transmission control apparatus according to claim 1, wherein
the generation information is stored in a generation information database, and the generation information stored in the generation information database is associated with a generation information ID for specifying the generation information and an authorized person ID for specifying an authorized person who uses the generation information,
the first receiving unit
receives the generation information ID and authorized person specification information for specifying the authorized person ID, and
comprises an ID confirmation unit that confirms whether or not the generation information ID received by the first receiving unit and the authorized person ID specified by the authorized person specification information received by the first receiving unit are matched with the generation information ID and the authorized person ID associated with the generation information stored in the generation information database, and
the electronic file generation unit
generates the electronic file in response to the confirmation of matching by the ID confirmation unit.

5. The electronic file transmission control apparatus according to claim 2, wherein
the generation information is stored in a generation information database, and the generation information stored in the generation information database is associated with a generation information ID for specifying the generation information and an authorized person ID for specifying an authorized person who uses the generation information,
the authorized person ID is described in the API call request,
the first receiving unit
receives the generation information ID, and
comprises an ID confirmation unit that confirms whether or not the generation information ID received by the first receiving unit and the authorized person ID described in the API call request are matched with the generation information ID and the authorized person ID associated with the generation information stored in the generation information database, and
the electronic file generation unit
generates the electronic file in response to the confirmation of matching by the ID confirmation unit.

6. The electronic file transmission control apparatus according to claim 3, wherein
the generation information is stored in a generation information database, and the generation information stored in the generation information database is associated with a generation information ID for specifying the generation information and an authorized person ID for specifying an authorized person who uses the generation information,
the first receiving unit
receives the generation information ID, and
comprises an authorized person ID detection unit that detects the authorized person ID based on information obtained from the email received by the first receiving unit, and
an ID confirmation unit that confirms whether or not the generation information ID received by the first receiving unit and the authorized person ID detected by the authorized person ID detection unit are matched with the generation information ID and the authorized person ID associated with the generation information stored in the generation information database, and
the electronic file generation unit
generates the electronic file in response to the confirmation of matching by the ID confirmation unit.

7. The electronic file transmission control apparatus according to claim 1, comprising:
a second transmission control unit that transmits the information for reading the electronic document represented by the electronic file generated by the electronic file generation unit to a computer of a confirmer of the electronic file; and
a second receiving unit that receives a transmission command from the computer of the confirmer, wherein
in response to the reception of the transmission command by the second receiving unit, the information for reading the electronic document represented by the electronic file generated by the electronic file generation unit is transmitted to the transmission destination represented by the first transmission destination data received by the first receiving unit.

8. The electronic file transmission control apparatus according to claim 2, wherein
information about a confirmer of the electronic file is described in the API call request,
the electronic file transmission control apparatus comprises
a third transmission control unit that transmits the information for reading the electronic document represented by the electronic file generated by the electronic file generation unit to a computer of the confirmer of the electronic file, and
a third receiving unit that receives a transmission command from the computer of the confirmer, and
in response to the reception of the transmission command by the third receiving unit, the information for reading the electronic document represented by the electronic file generated by the electronic file generation unit is transmitted to the transmission destination represented by the first transmission destination data received by the first receiving unit.

9. The electronic file transmission control apparatus according to claim 3, comprising:
a fourth transmission control unit that transmits the information for reading the electronic document represented by the electronic file generated by the electronic file generation unit to a transmission source of the email received by the first receiving unit; and
a fourth receiving unit that receives a transmission command from a computer of the transmission source, wherein
in response to the reception of the transmission command by the fourth receiving unit, the information for reading the electronic document represented by the electronic file generated by the electronic file generation unit is transmitted to the transmission destination represented by the first transmission destination data received by the first receiving unit.

10. The electronic file transmission control apparatus according to claim 1, wherein
the first receiving unit receives a generation information ID for specifying the generation information, and
comprises a generation information search unit that finds the generation information having the generation information ID received by the first receiving unit from a generation information database storing a plurality of pieces of generation information, and
the electronic file generation unit
generates the electronic file for displaying the character string represented by the text data received by the first receiving unit on the display screen in accordance with the generation information found by the generation information search unit.

11. The electronic file transmission control apparatus according to claim 1, wherein
the information for reading the electronic document is
at least one of the electronic file generated by the electronic file generation unit or information indicating a storage location of the electronic file generated by the electronic file generation unit.

12. An electronic file transmission control method comprising:
causing a first receiving unit to receive first transmission destination data representing a transmission destination of an electronic file having a file format capable of displaying, on a display screen, an electronic document in which a character string is represented in the same state as a state where the character string is represented on a paper sheet, and text data representing a character string to be transmitted to the transmission destination of the electronic file;
causing an electronic file generation unit to generate the electronic file for displaying the character string represented by the text data received by the first receiving unit on the display screen in accordance with generation information of the electronic document; and
causing a first transmission control unit to transmit information for reading the electronic document represented by the electronic file generated by the electronic file generation unit to the transmission destination represented by the first transmission destination data received by the first receiving unit.

13. A non-transitory tangible recording medium storing a computer-readable program for controlling a computer of an electronic file transmission control apparatus, the program causing the electronic file transmission control apparatus to execute:
receiving first transmission destination data representing a transmission destination of an electronic file having a file format capable of displaying, on a display screen, an electronic document in which a character string is represented in the same state as a state where the character string is represented on a paper sheet, and text data representing a character string to be transmitted to the transmission destination of the electronic file;
generating the electronic file for displaying the character string represented by the received text data on the display screen in accordance with generation information of the electronic document; and
transmitting information for reading the electronic document represented by the generated electronic file to the transmission destination represented by the received first transmission destination data.
